(19) United States
(12) Patent Application Publication
(10) Pub. No.: US 2010/0125715 A1
(43) Pub. Date: May 20, 2010

(54) Storage System and Operation Method Thereof

(75) Inventors: Kazuki Takamatsu, Sapporo (JP); Nobuo Beniyama, Yokohama (JP); Takuya Okamoto, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, ltd.

(21) Appl. No.: 12/356,788

(22) Filed: Jan. 21, 2009

(30) Foreign Application Priority Data
Nov. 18, 2008 (JP) 2008-294618

(51) Int. Cl. G06F 13/00; G06F 12/00

(52) U.S. Cl. 711/170; 710/74; 711/E12.001

(57) ABSTRACT

To efficiently assign storage resources to storage areas in a well-balanced manner in terms of performance and capacity, provided is a storage system in which, for a storage apparatus including a disk array group providing a logical volume to be assigned to an application, a storage management unit holds the throughput, response time, and storage capacity of the array group; receives performance density being a ratio between a throughput and a storage capacity, and a requirement on a storage capacity required for the logical volume; and assigns the throughput to the logical volume on the basis of the received performance density and the capacity requirement with the throughput of the array group set as an upper limit, and assigns, to the logical volume, a storage area determined on the basis of the assigned throughput and the received capacity requirement.

### CROSS-REFERENCE TO RELATED APPLICATION

The present application claims priority from Japanese Patent Application No. 2008-294618 filed on Nov. 18, 2008, which is herein incorporated by reference.

### BACKGROUND OF THE INVENTION

1. Field of the Invention

The present invention relates to a storage system and an operation method thereof, and more particularly to a storage system capable of efficiently assigning storage resources as storage areas in a well-balanced manner in terms of performance and capacity, and an operation method thereof.

2. Related Art

In recent years, with a main object to reduce system operation cost, optimization in the use of storage resources by storage hierarchization has been in progress. In storage hierarchization, storage apparatuses in the client's storage environment are categorized in accordance with their properties, and are used depending on requirements, so that effective use of resources is achieved.

To achieve this object, techniques as described below have heretofore been proposed. For example, Japanese Patent Application Laid-open Publication No. 2007-58637 proposes a technique in which logical volumes are moved to level the performance density of array groups. Further, Japanese Patent Application Laid-open Publication No. 2008-165620 proposes a technique in which, when configuring a storage pool, logical volumes forming the storage pool are determined so that concentration of traffic by the volumes on a communication path would not become a bottleneck in the performance of a storage apparatus. Furthermore, Japanese Patent Application Laid-open Publication No. 2001-147886 proposes another technique in which minimum performance is secured even when different performance requirements including a throughput, response, and sequential and random accesses are mixed.

However, it could not be said that these conventional techniques are capable of optimally assigning performance resources, e.g., data I/O performance, and capacity resources represented by a storage capacity in a storage apparatus in terms of performance requirements required for the storage apparatus so that the storage resources of the storage apparatus can be used with sufficient efficiency.

The present invention has been made in light of the above problem, and an object thereof is to provide a storage system capable of efficiently assigning storage resources to storage areas in a well-balanced manner in terms of performance and capacity, and an operation method thereof.

### SUMMARY OF THE INVENTION

To achieve the above and other objects, an aspect of the present invention is a storage system managing a storage device providing a storage area, the storage system including a storage management unit which holds performance information representing I/O performance of the storage device, and capacity information representing a storage capacity of the storage device, the performance information including a maximum throughput of the storage device; receives performance requirement information representing I/O performance required for the storage area, and capacity requirement information representing a requirement on a storage capacity required for the storage area, the performance requirement information including a required throughput; selects the storage device satisfying the performance requirement information and the capacity requirement information; and assigns, to the storage area, the required throughput included in the received performance requirement information, and assigns, to the storage area, the storage capacity determined on the basis of the capacity requirement information, the required throughput provided by the storage device with the maximum throughput of the storage device included in the performance information set as an upper limit, the storage capacity provided by the storage device with a total storage capacity of the storage device set as an upper limit.

Problems and methods for solving thereof disclosed in the present application will be more apparent from the following specification with reference to the accompanying drawings which relate to the Detailed Description of the Invention.

According to the present invention, storage resources can be efficiently assigned to storage areas in a well-balanced manner in terms of performance and capacity.

### BRIEF DESCRIPTION OF THE DRAWINGS

FIG. 1A is a diagram showing a configuration of storage system 1 according to a first embodiment of the present invention;

FIG. 1B is a diagram showing an example of a hardware configuration of a computer 100 to be used for a management server apparatus 10 and a service server apparatus 30;

FIG. 2 is a diagram schematically explaining performance density;

FIG. 3 shows an example of a disk drive data table 300;

FIG. 4 shows an example of an array group data table 400;

FIG. 5 shows an example of a group requirement data table 500;

FIG. 6 shows an example of a volume data table 600;

FIG. 7 shows an example of a configuration setting data table 700;

FIG. 8 shows an example of a performance limitation data table 800;

FIG. 9 is a flowchart showing an example of an entire flow of the first embodiment;

FIG. 10 is a flowchart showing an example of an array group data input flow of the first embodiment;

FIG. 11 shows an example of the created array group data table 400;

FIG. 12 is a flowchart showing an example of a volume creation planning flow of the first embodiment;

FIG. 13A shows an example of a group requirement setting screen 1300A;

FIG. 13B shows an example of a planning result screen 1300B;

FIG. 14 shows an example of the inputted group requirement data table 500;

FIG. 15 shows an example of a performance/capacity assignment calculation flow of the first embodiment;

FIG. 16 shows an example of the created volume data table 600;

FIG. 17 shows an example of the updated array group data table 400;

FIG. 18 shows an example of a volume creation flow of the first embodiment;

FIG. 19 shows an example of a performance monitoring flow of the first embodiment;

FIG. 20 shows an example (Part 1) of an existing volume classification flow of a second embodiment;

FIG. 21 shows an example of the volume data table 600 with an existing volume being updated;

FIG. 22 shows an example of the array group data table 400 with an existing volume being updated;

FIG. 23 shows an example (Part 2) of the existing volume classification flow of the second embodiment;

FIG. 24 is a table showing an example of the volume data table 600 with an existing volume updated;

FIG. 25 shows an example of the array group data table 400 with an existing volume updated;

FIG. 26 is a diagram showing a configuration of a storage system 1 according to a third embodiment in the present invention; and

FIG. 27 is a flowchart showing an example of an assignment flow of performance/capacity of a volume of the third embodiment.

### DETAILED DESCRIPTION OF THE INVENTION

Embodiments of the present invention will be described below with reference to the accompanying drawings.

### First Embodiment

### System Configuration

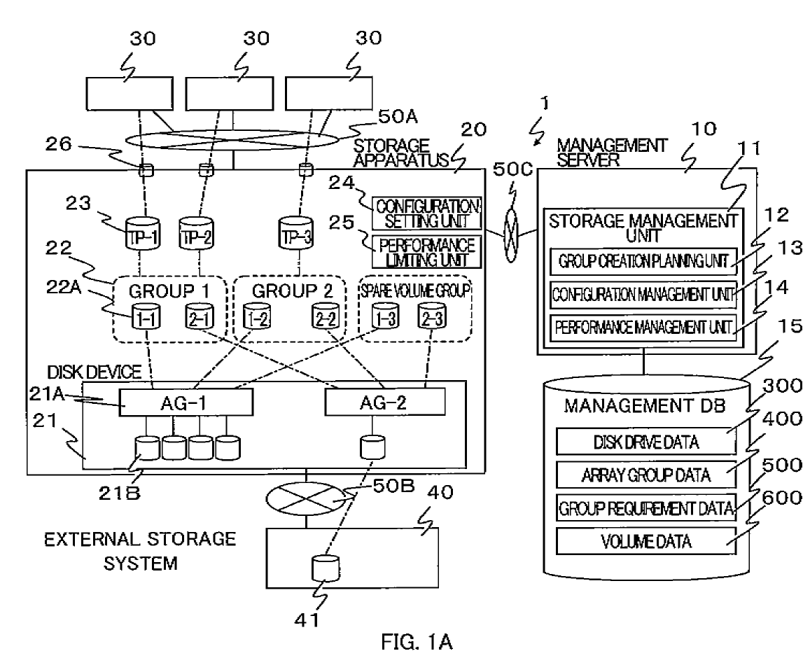

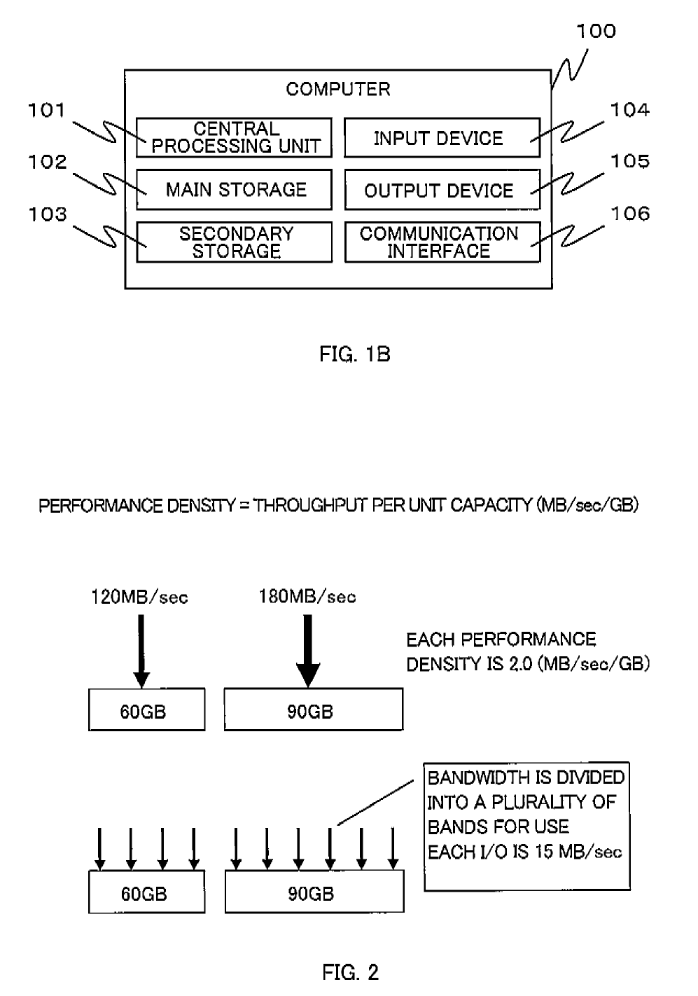

FIG. 1A shows a hardware configuration of a storage system 1 for explaining a first embodiment of the present invention. As shown in FIG. 1A, this storage system 1 includes a management server apparatus 10, a storage apparatus 20, service server apparatuses 30, and an external storage system 40.

Each of the service server apparatuses 30 and the storage apparatus 20 are coupled to each other via a communication network 50A, and the storage apparatus 20 and the external storage system 40 are coupled to each other via a communication network 50B. In the present embodiment, these networks are each a SAN (Storage Area Network) by using a Fibre Channel (hereinafter, referred to as an “FC”) protocol. Further, the management server apparatus 10 and the storage apparatus 20 are also coupled to each other via a communication network SOC which is a LAN (Local Area Network) in the present embodiment.

The service server apparatus 30 is a computer (an information apparatus) such as a personal computer or a workstation, for example, and performs data processing by using various business applications. To each of the service server apparatuses 30, volumes are assigned as areas in which data processed by the service server apparatus 30 is stored, the volumes being storage areas in the storage apparatus 20 which are to be described later. The service server apparatuses 30 may each have a configuration in which a plurality of virtual servers operate on a single physical server, the virtual servers being created by a virtualization mechanism (e.g. VMWare® or the like). That is to say, the three service server apparatuses 30 shown in FIG. 1A may each be a virtual server.

The storage apparatus 20 provides volumes being the above described storage areas to be used by applications working on the service server apparatuses 30. The storage apparatus 20 includes a disk device 21 being a physical disk, and has a plurality of array groups 21A by organizing a plurality of hard disks 21B included in the disk device 21 in accordance with a RAID (Redundant Array Inexpensive Disks) system.

Physical storage areas provided by these array groups 21A are managed by, for example, an LVM (Logical Volume Manager) as groups 22 of logical volumes each of which includes a plurality of logical volumes 22A. The group 22 of the logical volumes 22A is sometimes referred to as a “Tier.” In this specification, the term “group” represents the group 22 (Tier) formed of the logical volumes 22A. However, storage areas are not limited to the logical volumes 22A.

Specifically, in this embodiment, the groups 22 of the logical volumes 22A are further assigned to multiple virtual volumes 23 with so-called thin provisioning (hereinafter, referred to as a “TP”) provided by a storage virtualization mechanism not shown. Then, the virtual volumes 23 are used as storage areas by the applications operating on the service server apparatuses 30. Note that, these virtual volumes 23 provided by the storage virtualization mechanism are not essential to the present invention. As will be described later, it is also possible to have a configuration in which the logical volumes 22A are directly assigned to the applications operating on the service server apparatuses 30, respectively.

Further, provision of a virtual volume with thin provisioning is described, for example, in U.S. Pat. No. 6,823,442 (“METHOD OF MANAGING VIRTUAL VOLUMES IN A UTILITY STORAGE SERVER SYSTEM”).

The storage apparatus 20 further includes: a cache memory (not shown); a LAN port (not shown) forming a network port with the management server apparatus 10; an FC interface (FC-IF) providing a network port for performing communication with the service server apparatus 30; and a disk control unit (not shown) that performs reading/writing of data from/on the cache memory, as well as reading/writing of data from/on the disk device 21.

The storage apparatus 20 includes a configuration setting unit 24 and a performance limiting unit 25. The configuration setting unit 24 forms groups 22 of logical volumes 22A of the storage apparatus 20 following an instruction from a configuration management unit 13 of the management server apparatus 10 to be described later.

The performance limiting unit 25 monitors, following an instruction from a performance management unit 14 of the management server apparatus 10, the performance of each logical volume 22A forming the groups 22 of the storage apparatus 20, and limits the performance of FC-IFs 26 when necessary. Functions of the configuration setting unit 24 and the performance limiting unit 25 are provided, for example, by executing programs corresponding respectively thereto, the programs being installed on the disk control unit.

The external storage system 40 is formed by coupling a plurality of disk devices 41 with each other via a SAN (Storage Area Network), and alike the storage apparatus 20, the external storage system 40 is externally coupled with the SAN being the communication network 50B to provide usable volumes as storage areas of the storage apparatus 20.

The management server apparatus 10 is a management computer in which main functions of the present embodiment are mounted. To the management server apparatus 10, a storage management unit 11 managing configurations of the groups 22 of the storage apparatus 20 is provided. The storage management unit 11 includes a group creation planning unit 12, the configuration management unit 13, and the performance management unit 14.

The group creation planning unit 12 plans assignment of the logical volumes 22A to the array groups 21A on the basis of maximum performance and maximum capacity of each array group 21A, and of requirements (performance/capacity), inputted by the user, which each group 22 is expected to have. The maximum performance and maximum capacity of each array group 21A being included in storage information acquired from the storage apparatus 20 in accordance with a predetermined protocol.

The configuration management unit 13 has a function of collecting storage information in SAN environment. In the example of FIG. 1A, as described above, the configuration management unit 13 provides, to the group creation planning unit 12, storage information acquired in accordance with a predetermined protocol from the array groups 21A included in the storage apparatus 20 and the disk devices 41 in the external storage system 40. In addition, the configuration management unit 13 instructs the storage apparatus 20 to create logical volumes 22A in accordance with the assignment plan of the logical volumes 22A created by the group creation planning unit 12.

The performance management unit 14 instructs the performance limiting unit 25 of the storage apparatus 20 to monitor performance of each logical volume 22A and limit the performance when necessary, on the basis of the performance assignment of the logical volumes 22A planned by the group creation planning unit 12. For example, methods for limiting the performance of the logical volumes 22A include: limiting performance on the basis of a performance index in a storage port in the storage apparatus 20 (more specifically, an amount of I/O is limited in units of the FC-IF 26 accessing the logical volumes 22A); limiting performance with focus on when data is written back from the cache memory to the hard disks 21B (and vice versa) in the storage apparatus 20; and limiting performance in a host device (the service server apparatus 30) using the logical volumes 22A.

To the management server apparatus 10, a management database 15 is further provided. In the management database 15, a disk drive data table 300, an array group data table 400, a group requirement data table 500, and a volume data table 600 are stored. Roles of these tables will be described later. Data in these tables 300 to 600 are not necessarily stored in databases, but may simply be stored in a suitable storage apparatus of the management server apparatus 10 in a form of a table.

FIG. 1B shows an example of a computer 100 usable for the management server apparatus 10 or the service server apparatus 30. The computer 100 includes: a central processing unit 101 (e.g., a CPU (Central Processing Unit) or an MPU (Micro Processing Unit)); a main storage 102 (e.g., a RAM (Random Access Memory) or a ROM (Read Only Memory)); a secondary storage 103 (e.g., a hard disk); an input device 104 (e.g., a keyboard or a mouse) receiving input from the user; an output device 105 (e.g., a liquid crystal monitor); and a communication interface 106 (e.g., an NIC (Network Interface Card) or an HBA (Host Bus Adapter)) achieving communications with other apparatuses.

Functions of the group creation planning unit 12, the configuration management unit 13, and the performance management unit 14 of the management server apparatus 10 are achieved in such a way that the central processing unit 101, reads out to the main storage 102 programs for implementing the corresponding functions stored in the secondary storage 103, and executes the programs.

### ==Description of Data Tables==

First, described is performance density to be used in the present embodiment as an index for determining whether or not the logical volume 22A has sufficient performance necessary for the operation of the applications. FIG. 2 is a diagram schematically explaining the performance density. The performance density is defined as a value obtained by dividing throughput (unit; MB/s) representing data I/O performance of the disk device 21 forming the logical volumes 22A by storage capacity (unit: GB) of the disk device 21.

As shown in FIG. 2, when considering the case of accessing a storage capacity of 60 GB with a throughput of 120 MB/s, and the case of accessing a storage capacity of 90 GB with a throughput of 180 MB/s, both have performance density of 2.0 MB/s/GB and are evaluated to be the same. When actual performance density is high as compared to performance density required for applications using the logical volumes 22A formed by the disk device 21, it shows a tendency in which a storage capacity is not sufficient for a throughput. By contrast, when actual performance density is low as compared to the required performance density, it shows a tendency in which a throughput is not sufficient for a storage capacity.

A typical application suitable for evaluating data I/O performance in this performance density includes a general server application, e.g., an e-mail server application, in which a processing is performed so that data input and output can be performed in parallel and storage areas are uniformly used for the data I/O.

Next, tables to be referred in the present embodiment will be described.

### Disk Drive Data Table 300

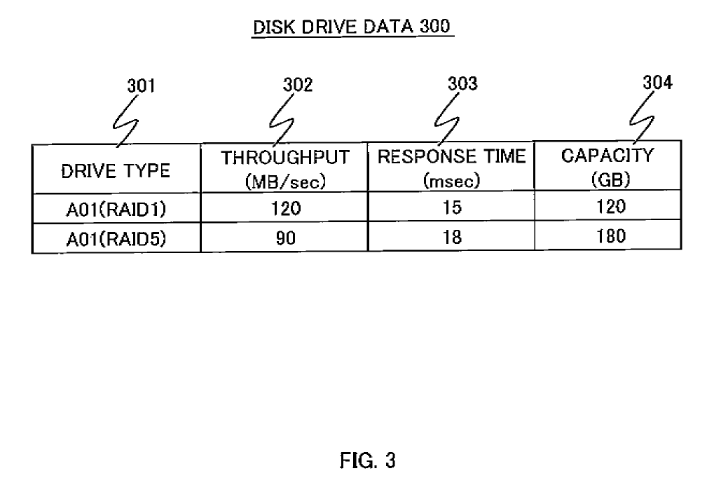

In the disk drive data table 300, for each drive type 301 including an identification code of a hard disk 21B (e.g., a model number of a disk drive) and a RAID type applied to the hard disk 21B, a maximum throughput 302, response time 303, and a storage capacity 304 to be provided corresponding to the hard disk 21B are recorded. FIG. 3 is a table showing an example of the disk drive data table 300.

These data are inputted in advance, by an administrator, for all the disk devices 21 usable in the present embodiment. Incidentally, data on the usable disk devices 41 of the external storage system 40 are also recorded in this table 300.

### Array Group Data Table 400

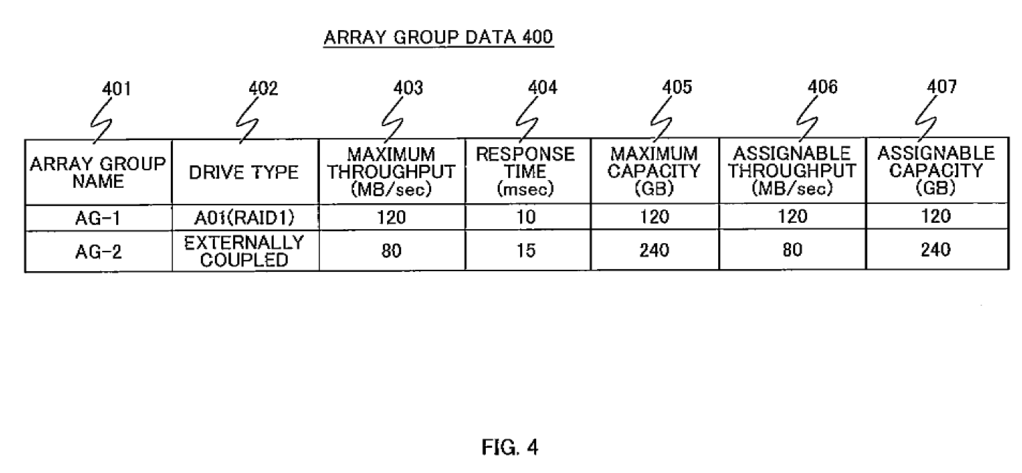

The array group data table 400 stores therein performance and capacity of each array group 21A included in the storage apparatus 20. In the array group data table 400, for each array group name 401 representing an identification code for identifying each array group 21A, the following are recorded: a drive type 402 of each hard disk 21B included in the array group 21A; a maximum throughput 403; response time 404; a maximum capacity 405; an assignable throughput 406; and an assignable capacity 407. FIG. 4 shows an example of the array group data table 400.

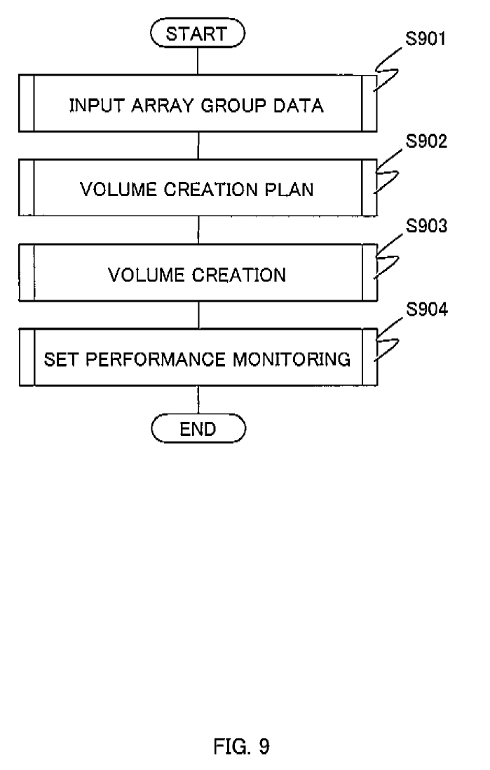

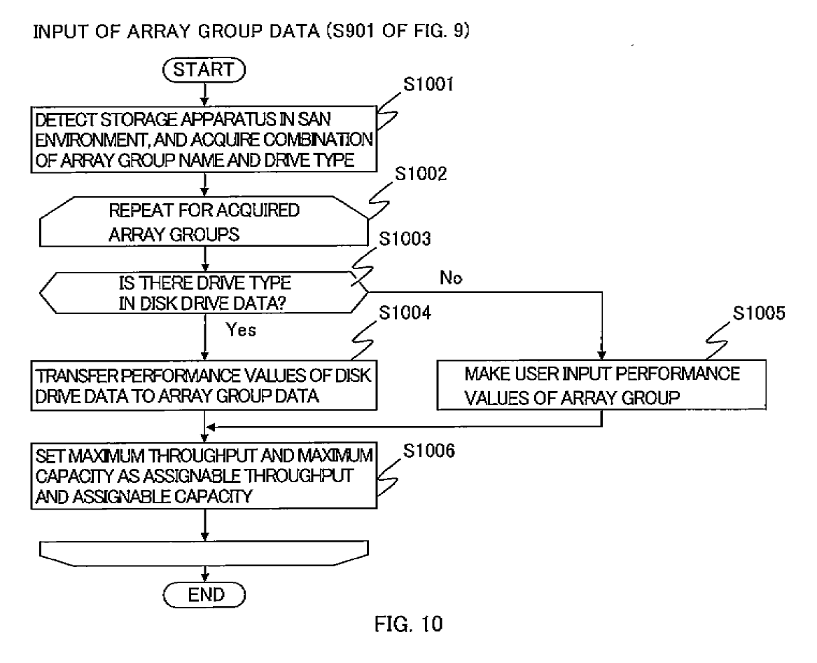

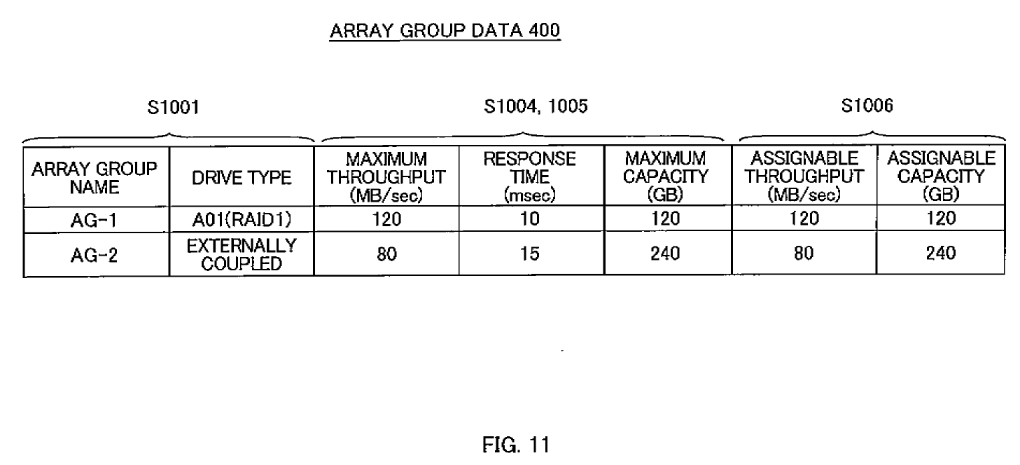

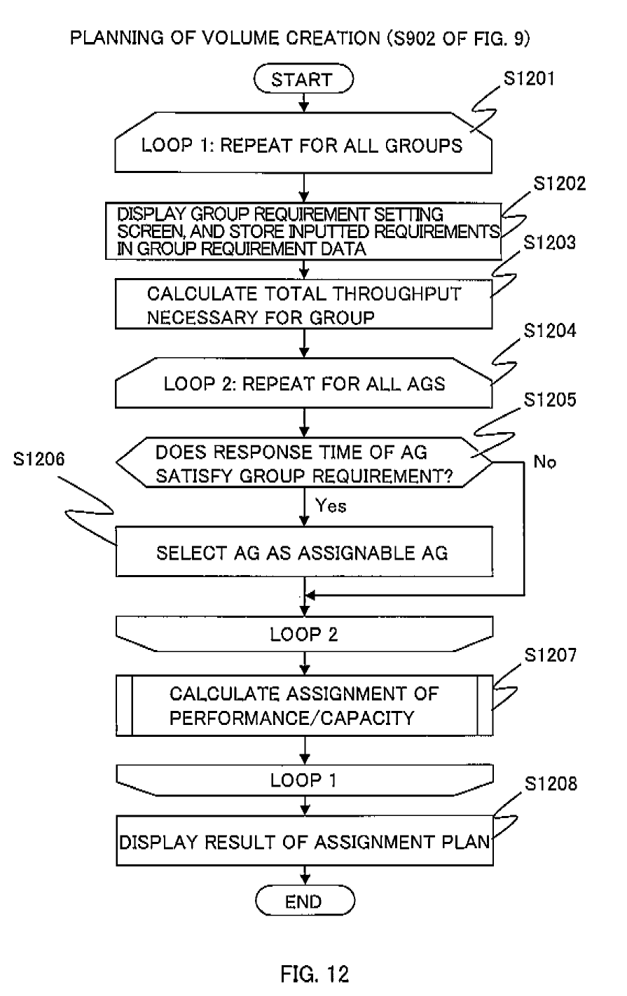

The drive type 402, the maximum throughput 403, and the response time 404 are the same as those recorded in the disk drive data table 300. The maximum capacity 405, the assignable throughput 406, and the assignable capacity 407 will be described later in a flowchart of FIG. 9.

### Group Requirement Data Table 500

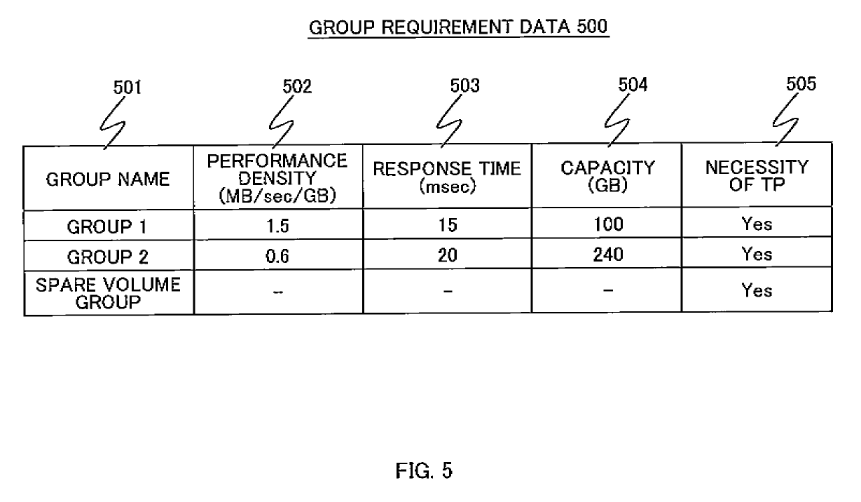

The group requirement data table 500 stores therein requirements of each group (Tier) 22 included in the storage apparatus 20. FIG. 5 shows an example of the group requirement data table 500.

In the group requirement data table 500, a group name 501 representing an identification code for identifying each group 22, and performance density 502, response time 503, and a storage capacity 504 which are required for each of the group 22 are recorded in accordance with an input by an administrator. In addition, in the present embodiment, necessity of virtualization 505 representing an identification code for setting whether to use the function of the storage virtualization mechanism is also recorded.

### Volume Data Table 600

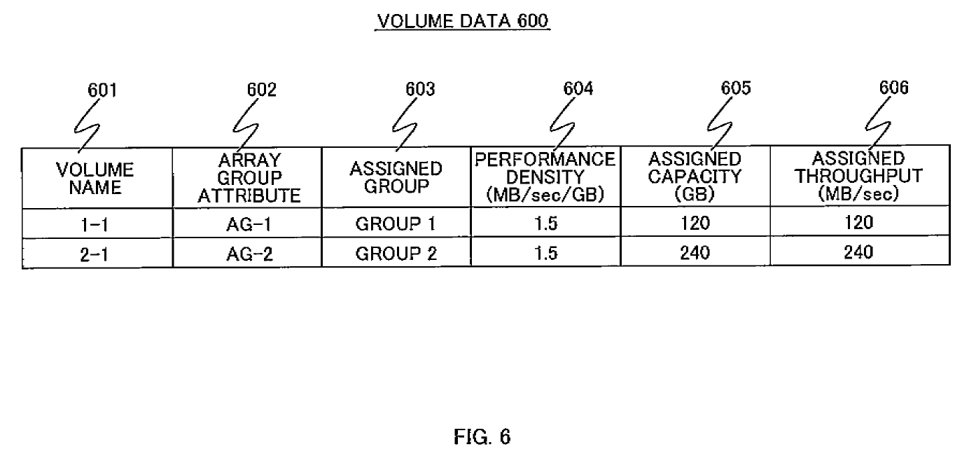

In the volume data table 600, for each logical volume 22A assigned to the groups 22 in the present embodiment, the following are recorded: a volume name 601 of the logical volume 22A; an array group attribute 602 representing an identification code of an array group 21A to which the logical volume 22A belongs; a group name 603 of a group 22 to which the logical volume 22A is assigned; as well as performance density 604, an assigned capacity 605, and an assigned throughput 606 of each logical volume 22A. FIG. 6 shows an example of the volume data table 600. This volume data table 600 is created with a flow shown in FIG. 9 as will be described later.

Next, tables held in the storage apparatus 20 will be described.

### Configuration Setting Data Table 700

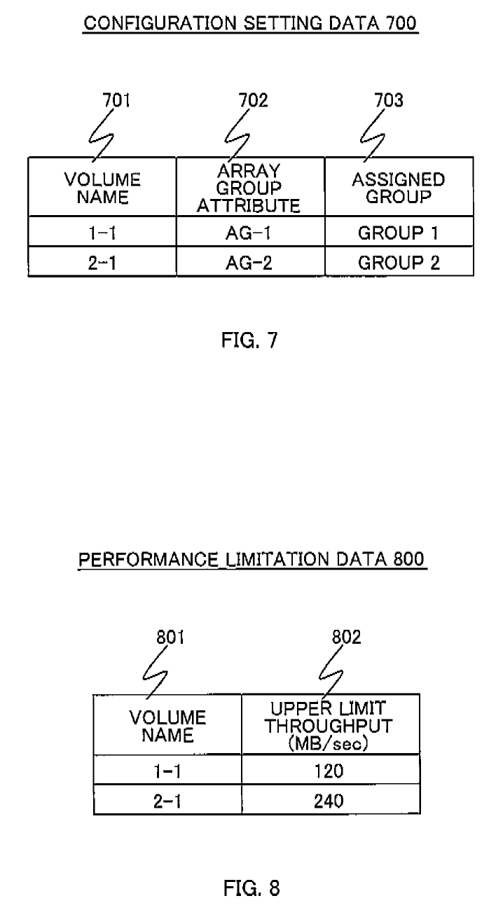

A configuration setting data table 700 is stored in the configuration setting unit 24 of the storage apparatus 20. In the configuration setting data table 700, for a volume name 701 of each logical volume 22A, an array group attribute 702 and an assigned group 703 of each logical volume 22A are recorded. FIG. 7 shows an example of the configuration setting data table 700. This table 700 is used by the configuration setting unit 24.

### Performance Limitation Data Table 800

In a performance limitation data table 800, for a volume name 801 of each logical volume 22A, an upper limit throughput 802 which can be set for the logical volume 22A is recorded. FIG. 8 shows an example of the performance limitation data table 800. This table 800 is stored in the performance limiting unit 25 of the storage apparatus 20, and used by the performance limiting unit 25. Next, an operation of the storage system 1 according to the first embodiment will be described with reference to the drawings.

### Entire Flow

FIG. 9 shows an entire flow of processing to be performed in the present embodiment. A schematic description of contents in the processing in this entire flow will be given as follows. First, the configuration management unit 13 of the management server apparatus 10 acquires storage information such as a drive type from the storage apparatus 20 coupled to the management server apparatus 10 under SAN environment in accordance with a predetermined protocol. Subsequently, the configuration management unit 13 extracts a maximum throughput, response time, and a maximum capacity of each array group 21A corresponding to the storage information thus acquired, and then stores them in the array group data table 400 of the management database 15 (S901).

Next, the group creation planning unit 12 of the management server apparatus 10 creates an assignment plan in accordance with the requirements of performance and capacity inputted by the administrator, and stores the result thus created in the volume data table 600 of the management database 15 (5902).

Subsequently, referring to data recorded in the volume data table 600, the configuration management unit 13 of the management server apparatus 10 transmits the created setting to the configuration setting unit 24 of the storage apparatus 20, and the configuration setting unit 24 creates a logical volume 22A specified by the setting (S903).

Thereafter, the performance managing unit 14 of the management server apparatus 10 transmits settings to the performance limiting unit 25 of the storage apparatus 20 based on the volume data table 600, and then the performance limiting unit 25 monitors/limits performance in accordance with the contents of the setting (S904).

Next, each step forming the entire flow of FIG. 9 will be described by using detailed flows.

### Input of Array Group Data (S901 of FIG. 9)

FIG. 10 shows an example of a flow in which data is inputted into the array group data table 400. First, the configuration managing unit 13 of the management server apparatus 10 detects the storage apparatus 20 coupled to the management server apparatus 10 under the SAN environment, and collects the storage information in accordance with the predetermined protocol. In the present embodiment, the configuration management unit 13 acquires the array group name 401 and the drive type 402 from the storage apparatus 20 (S1001). The array group 21A may be a virtualized disk; for example, the array group name “AG-2” recorded in the array group data table 400 of FIG. 4 is created from a disk included in the external storage system 40 which is externally coupled to the storage apparatus 20. The information acquired herein is recorded in the array group data table 400.

Next, in S1002, for all the array groups 21A detected in S1001, processes defined in S1003 to S1006 will be performed.

First, the configuration managing unit 13 checks whether or not the drive type 402 recorded in the array group data table 400 is present in the disk drive data table 300 (S1003). When it is present (Yes in S1003), the configuration managing unit 13 acquires the maximum throughput 302, the response time 303, and the maximum capacity 304 corresponding to the drive type 402, and stores them in the array group data table 400 at columns corresponding thereto.

When the drive type 402 is not present on the disk drive data table 300 (No in S1003), the configuration management unit 13 presents to the administrator am input screen for inputting performance values of the corresponding array group 21A so as to make the administrator input the maximum throughput 302, the response time 303, and the maximum capacity 304 as the performance values. Values inputted by the administrator are recorded in the array group data table 400.

Next, the configuration managing unit 13 records the maximum throughput 403 and the maximum capacity 405 recorded in the array group data table 400 as initial values of the assignable throughput 406 and the assignable capacity 407, respectively.

FIG. 11 shows an example of the array group data table 400 created in the above-described manner. In FIG. 11, items recorded in the array group data table 400 are shown in association with processing steps by which these items are recorded.

### Volume Creation Plan (S902 of FIG. 9)

Next, the group creation planning unit 12 of the management server apparatus 10 performs plan creation for the logical volumes 22A, forming each of the groups 22, which are to be assigned to each application of the service server apparatuses 30. FIG. 12 shows an example of a flow for performing this volume creation plan.

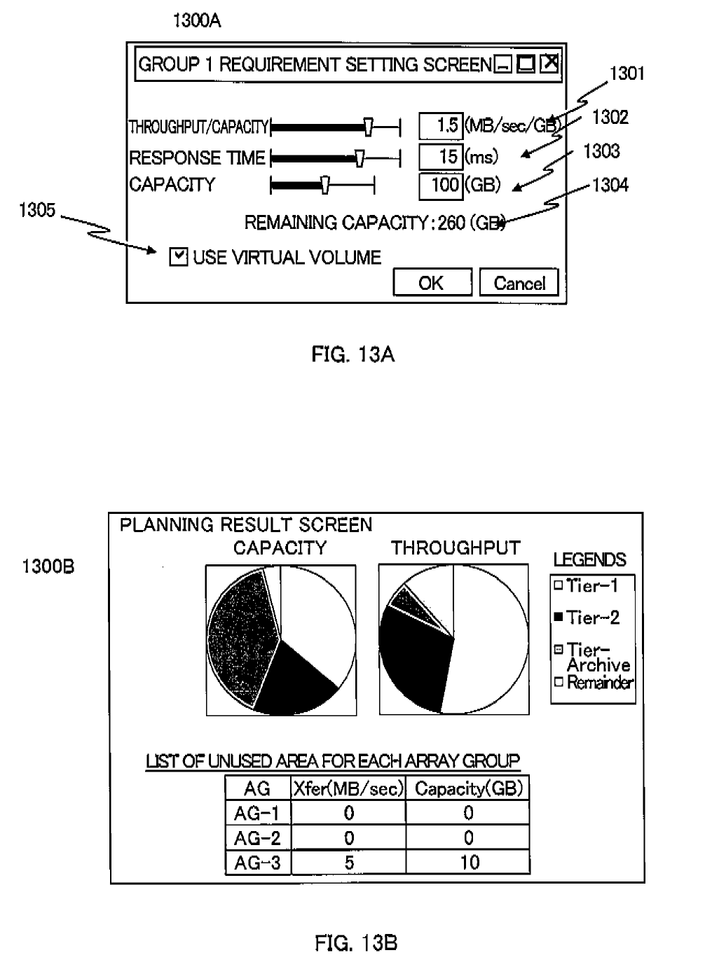

The group creation planning unit 12 performs steps of S1202 to S1207 for all the groups 22. First, the group creation planning unit 12 displays a group requirement setting screen 1300 to the administrator so as to make the administrator input requirements which the group 22 is expected to have. FIG. 13A shows an example of the group requirement setting screen 1300. Values inputted by the administrator through this screen 1300 are recorded in the group requirement data table 500 (S1202).

In the group requirement setting screen 1300 illustrated in FIG. 13A, as input values to be inputted by the administrator, performance density (throughput/capacity) 1301, response time 1302, and a capacity 1303 to be required are set. When the capacity 1303 is not specified by the administrator, maximum capacity is assigned instead.

A group 22, an assigned throughput of which is 0, is usually used as an archive area being a spare storage area. A value obtained by subtracting the capacity 1303 thus specified from a total value of the assignable capacity is displayed as a remaining capacity 1304.

Next, the group creation planning unit 12 calculates a total throughput necessary for the group 22 from the requirements inputted by the administrator (S1203). In the example of FIG. 13A (performance density=1.5, response time=15, capacity=100), a total throughput is 1.5×100=150 (MB/sec).

Next, in S1204, the group creation planning unit 12 repeats processing of S1205 to S1206 for all the array groups 401 recorded in the array group data table 400.

In S1205, it is determined whether or not the response time 404 of the array group 401 of focus satisfies the performance requirement of the group 22. In the example of FIG. 4, the array group name “AG-1” and “AG-2” both satisfy a requirement at a value of 15 ms specified in FIG. 13A by the administrator.

When determined that the requirement is satisfied (Yes in S1205), the array group 21A having been determined that the requirement is satisfied is selected as an assignable array group 21A (S1206). When determined that the requirement is not satisfied (No in S1205), the array group 21A is not to be selected.

Next, for each group 22, the group creation planning unit 12 performs assignment calculation of performance/capacity to obtain (S1207) performance/capacity to be assigned to the array group 21A. Detailed flow of this process will be described later.

Last, the group creation planning unit 12 makes an assignment plan of array groups 21A for all the groups 22 and, thereafter, displays an assignment result screen 1300B showing a result of the planning. FIG. 13B shows an example of the assignment result screen 1300B. When the remaining capacity and performance are low, or when the capacity and performance assigned to a spare volume group 22 are low, it is considered that the array groups 21A have effectively been assigned to upper groups 22.

Incidentally, when the performance of a disk is exhausted and only the capacity thereof remains, the disk is assigned to the spare volume group 22 so that the disk can be used for archiving (storing) of data that is not used normally. Meanwhile, when the capacity of a disk is exhausted and only the performance thereof remains, the disk will be wasting resources. In this case, by increasing a performance requirement of the upper groups 22, the remaining capacity can be reduced.

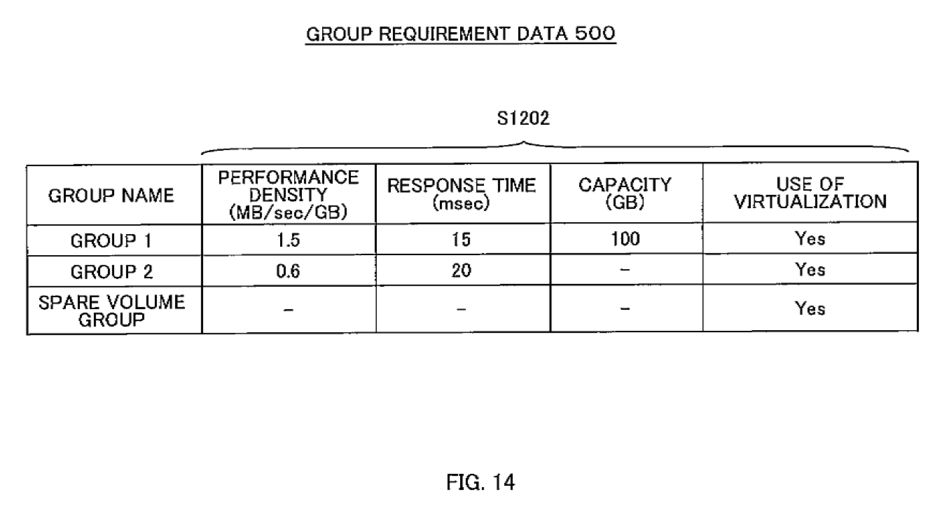

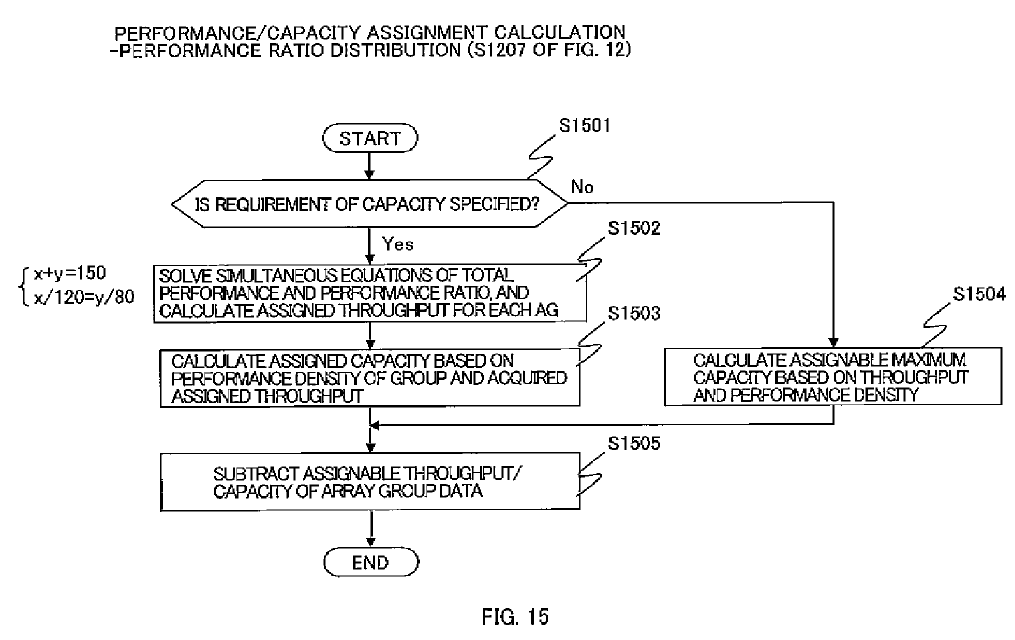

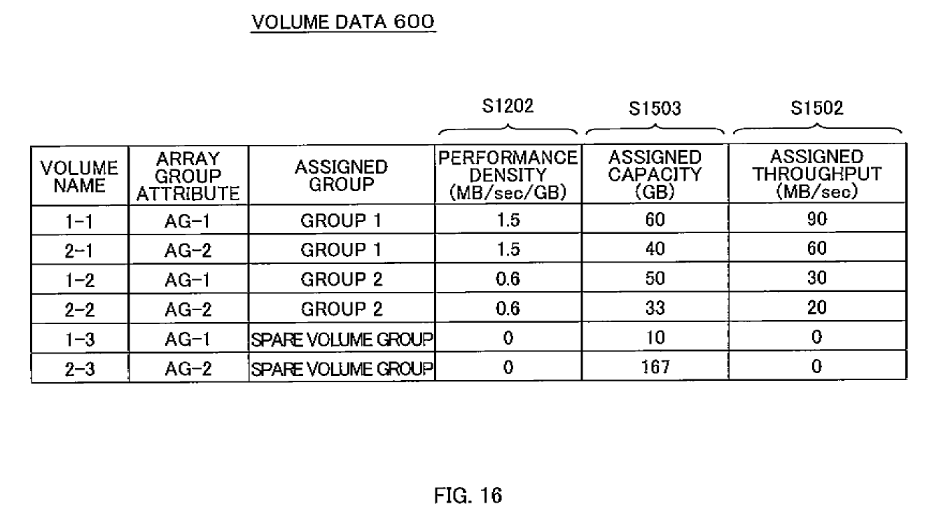

FIG. 14 shows an example of the group requirement data table 500 created in this step.

### Assignment Calculation of Performance/Capacity (S1207 of FIG. 12)

Next, assignment calculation of performance/capacity to be performed in S1207 of FIG. 12 will be described with reference to an example of a processing flow shown in FIG. 15. In the present embodiment, shown is an example of the case where performance/capacity assignment to each array group 21A in the same group 22 is performed on the basis of an “assignment by dividing in accordance with performance ratio” scheme.

In this assignment scheme, determination is made such that the following three conditions are met: (i) A total value of the performance assigned to the array groups 21A is equal to a total throughput obtained in S1203 of FIG. 12; (ii) A ratio between assigned throughput and maximum throughput is the same for all the array groups 21A; and (iii) The performance density of the logical volume 22A assigned to each array group 21A is equal to a value inputted by the administrator through the group requirement setting screen 1300.

First, the group creation planning unit 12 of the management server apparatus 10 determines (S1501) whether or not the capacity 1303 has been specified by the administrator as a requirement of a group 22 for which processing is to be performed.

If determined that the capacity 1303 has been specified (Yes in S1501), when performance assigned to each selected array group 21A is denoted by X_i, and when maximum performance of each array group 21A is denoted by Max_i (here, “i” represents an ordinal number attached to each array group 21A), the following simultaneous equations are solved so as to find an assigned throughput (S1502):

(i) □X_i (Total throughput necessary for the group 22)

(ii) X_i/Max_i is constant (X_{—}1/Max_{—}1=X_{—}2/Max_{—}2= . . . ).

Since the total throughput needs to satisfy the performance value required for each group 22, condition (i) is requisite. Further, the condition (ii) is requisite since the assignment scheme is employed in which assignment is made so that assigned performance can correspond to the maximum performance of each array group 21A.

In the example of FIG. 11, as a combination of assigned throughputs satisfying the conditions; (i) X_{—}1+X_{—}2=150, (ii) X_{—}1/120=X_{—}2/80, X_{—}1=90 and X_{—}2=60 are obtained.

Next, the group creation planning unit 12 calculates assigned capacity from performance density specified by the administrator, and the assigned throughput obtained above. In the case of the example of FIG. 13A, assigned capacity to the array group “AG-1” is given by (Assigned throughput, 90)÷(Performance density, 1.5)=60 GB, and similarly, assigned capacity to the array group “AG-2” is given by 60÷1.5=40 GB (S1503).

Subsequently, the group creation planning unit 12 subtracts the assigned throughput and assigned capacity calculated above from the assigned throughput 606, and the assigned capacity 605 recorded in the array group data table 400. In this example, after subtraction, the obtained results are 30 (MB/sec) and 60 GB for array group “AG-1”, and 20 (MB/sec) and 200 GB for array group “AG-2,” respectively. These values show the remaining storage resources usable for the next group 22.

When capacity is not specified by the administrator (No in S1501), a maximum capacity in performance density specified by the administrator is calculated from the assignable throughput/capacity. Further, as in the case of the spare volume group 22, when the required performance density is 0 (assigned throughput is 0), all the remaining assignable capacity is assigned as it is. Meanwhile, when the capacity of a disk is exhausted and only the performance thereof remains, this means that the disk will be wasting its resources. In this case, by increasing a performance requirement of the upper Tiers, the remaining performance can be reduced.

In an example of FIG. 16, the capacity of “Group 2” is not yet specified. In this case, 50 GB is specified as a volume “1-2” for group “Group 2” by exhausting an assignable throughput, 30 (MB/sec) of the array group “AG-1,”, and 33 GB is specified as a volume “2-2” for group “Group 2” by exhausting an assignable throughput, 20 (MB/sec), of the array group “AG-2.” To volumes “1-3” and “2-3” for the spare volume group 22, all the remaining capacity is assigned, which means that, with referring to the array group data table 400 of FIG. 4, they are 10 GB and 167 GB, respectively.

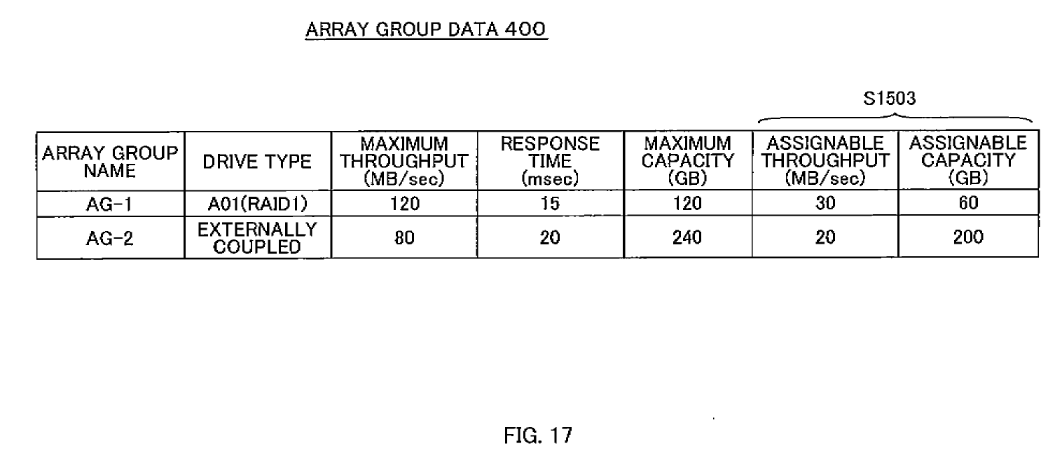

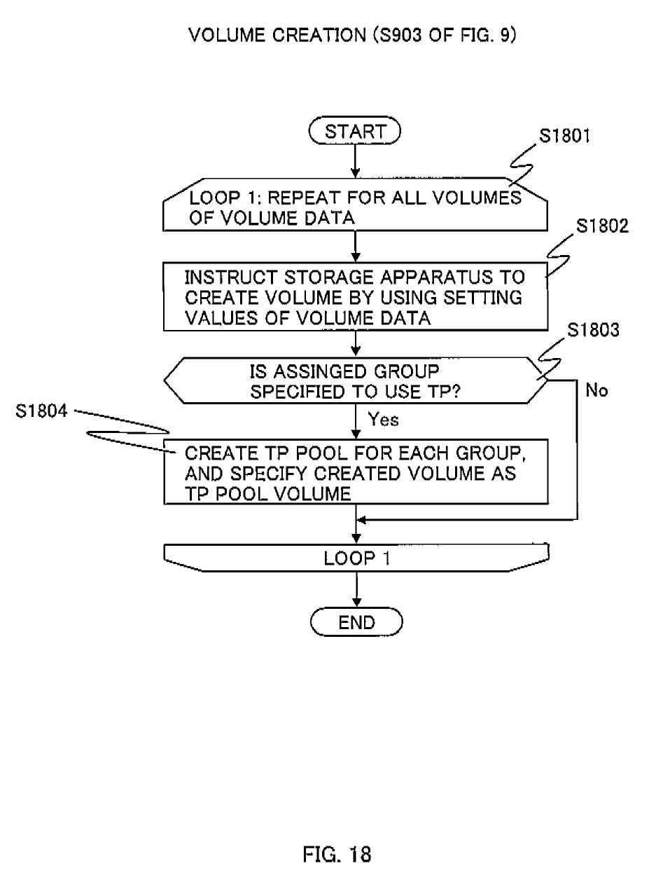

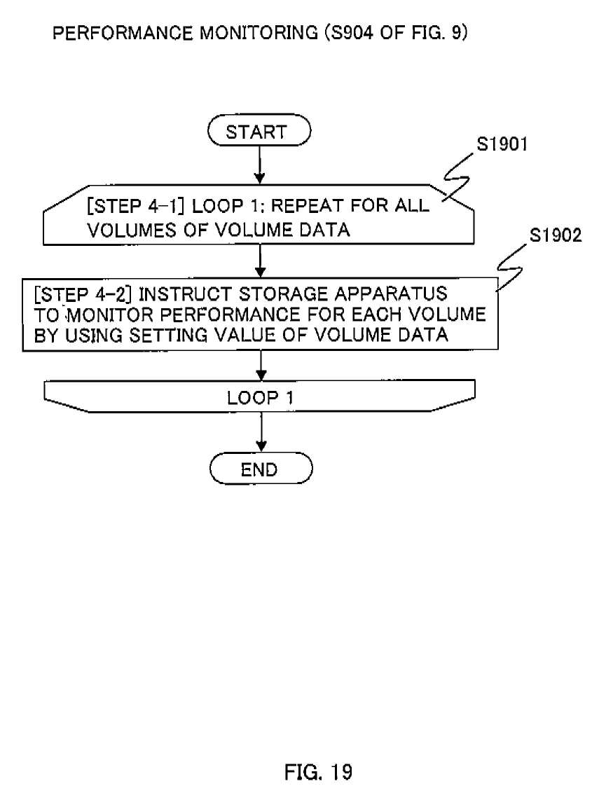

After completing the above performance/capacity assignment processing, the flow of the volume creation plan shown in FIG. 12 is terminated. FIGS. 16 and 17 show examples of the volume data table 600 and the array group data table 400 created or updated in the volume creation plan processing flow.

### Volume Creation (S903 of FIG. 9)

Next, contents of a volume creation processing for creating a volume determined in the volume creation plan processing will be described. FIG. 18 shows a detailed flow of the volume creation processing.

First, in S1801, the configuration management unit 13 of the management server apparatus 10 repeats processing of S1801 to S1804 for all volumes recorded in the volume data table 600.

The configuration management unit 13 specifies the array group attribute 602 and assigned capacity 605 of each volume 22A recorded in the volume data table 600, and instructs the configuration setting unit 24 of the storage apparatus 20 to create a logical volume 22A (S1802).

Next, the configuration management unit 13 of the management server apparatus 10 determines whether or not the assigned group 603 of the logical volume 22A has been specified to use the TP method using the virtual volume 23 (S1803).

When specified to use the virtual volume 23 (Yes in S1803), the configuration management unit 13 of the management server apparatus 10 instructs the configuration setting unit 24 of the storage apparatus 20 to create a TP pool serving as a basis of creating a virtual volume 23 for each group 22, and the configuration management unit 13 makes an instruction to add the volume 22A thus created to the TP pool. The configuration management unit 13, further, makes an instruction to create a virtual volume 23 from the TP pool, according to need.

When logical volumes provided by the TP are used to create virtual volumes for assignment in this manner, the virtual volumes can be assigned so that the capacity usage rates of volumes within a pool are uniform. Thereby, the advantage can be achieved in which even in a state where part of the assigned disk capacity is in use, volumes can be assigned with load-balanced traffic.

When use of the virtual volume 23 is not specified (No in S1803), the processing is terminated.

### Performance Monitoring (S904 of FIG. 9)

Next, contents of performance monitoring processing by the performance management unit 14 of the management server apparatus 10 will be described. FIG. 19 shows an example of the performance monitoring processing.

In S1901, the performance management unit 14 performs a process of S1902 for all the volumes 22A recorded in the volume data table 600.

Specifically, the performance management unit 14 of the management server apparatus 10 specifies the assigned throughput 606 of each volume 22A recorded in the volume data table 600, and instructs the performance limiting unit 25 of the storage apparatus 20 to perform performance monitoring for each volume 22A (S1902). In response to this instruction, the performance limiting unit 25 monitors the throughput of each volume 22A, and when determining that the throughput has exceeded the assigned throughput 606, the performance limiting unit 25 performs a processing of, for example, restricting a port on the FC-IF 26 so as to reduce an amount of data I/O.

Further, before performing such a performance limiting processing, the performance limiting unit 25 may notify the performance management unit 14 of the management server apparatus 10 of a notice indicating that the throughput of the specific volume 22A has exceeded an assigned value, and cause the performance management unit 14 to notify the administrator of the notice.

In accordance with the first embodiment having been described above, storage resources can be efficiently managed in a good balance in terms of performance and capacity.

### Second Embodiment

Next, a second embodiment of the present invention will be described. In the first embodiment, a configuration has been described in which logical volumes 22A are newly created from an array group 21A and assigned to each group (Tier) used by an application. However, in the present embodiment, logical volumes 22A are assumed to have already been created, and the present invention is applied to the case where some of the logical volumes 22A are being used.

A system configuration and configurations of data tables are the same as those of the first embodiment, so that only changes of processing flows will be described below.

In the present embodiment, in the entire flow of FIG. 9, a step of acquiring information on an existing volume 22A is added at the time of recognition of the storage apparatus 20 in SAN environment shown in S901. Further, in the volume creation planning process shown in S902 (refer to FIG. 12 for a detailed flow), the calculation of performance/capacity assignment shown in S1207 is changed.

### Change in Input Processing of Array Group Data

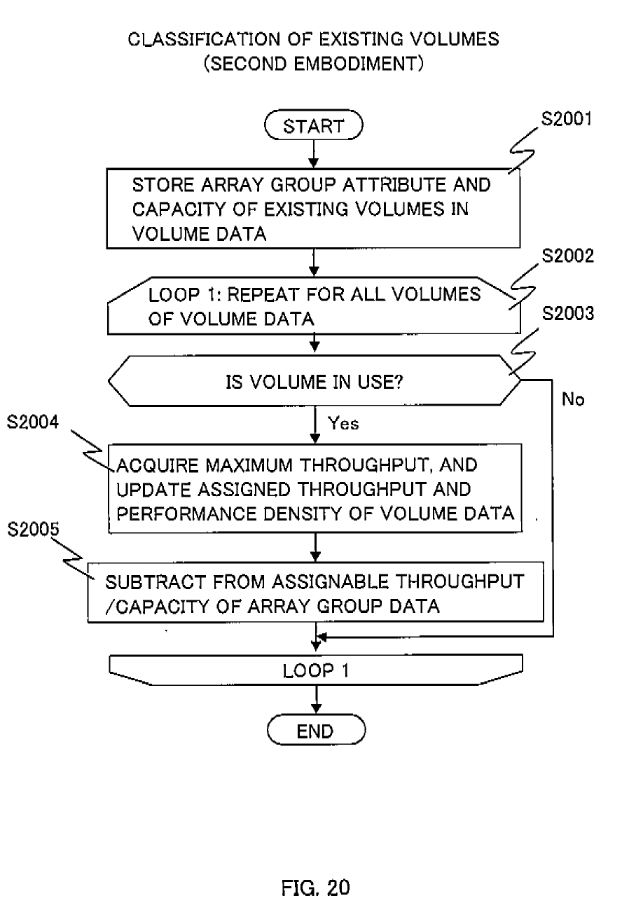

S1006 in the detailed flow of FIG. 10 is replaced by a flow including a processing of acquiring information on the existing volume 22A to be described below: An example of this changed flow is shown in FIG. 20.

First, for an existing volume 22A, the configuration management unit 13 of the management server apparatus 10 acquires the array group attribute 602 to which the existing volume 22A belongs, and the capacity 603 from the configuration setting unit 24 of the storage apparatus 20, and stores them in the volume data table 600 (S2001).

In S2002, for all the existing volumes 22A acquired in S2001, processing S2003 to S2005 is repeated.

First, the configuration management unit 13 of the management server apparatus 10 makes an inquiry to the configuration setting unit 24 of the storage apparatus 20 to determine whether or not the existing volume 22A is in use (S2003).

When determining that the existing volume 22A is in use (Yes in S2003), maximum throughput for the volume 22A is acquired and stored in the assigned throughput 605 of the volume data table 600. In addition, the performance density 604 of the existing volume 22A is calculated from the capacity 603 and the throughput 605, and is similarly stored in the volume data table 600 (S2004).

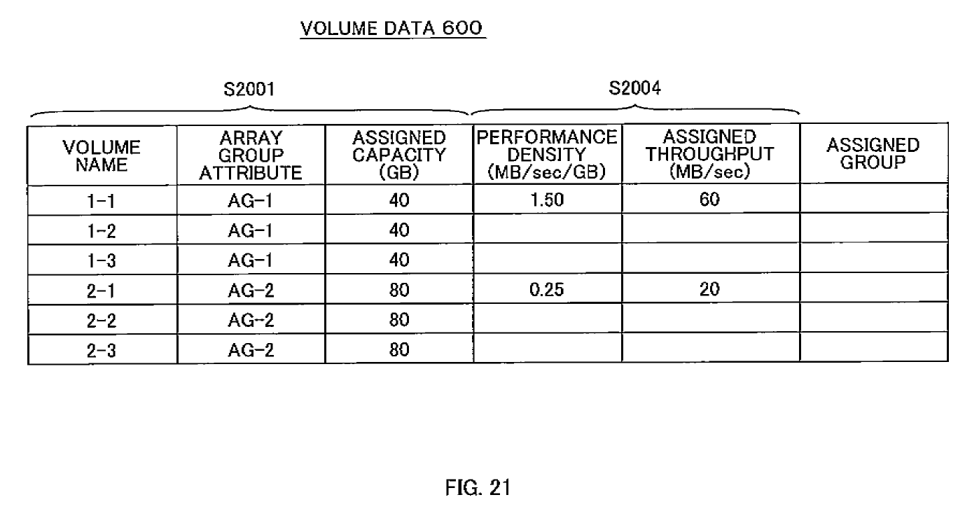

FIG. 21 shows an example of the volume data table 600 generated in this process. In the example of FIG. 21, existing volumes “1-1” and “2-1” are in use, and performance densities calculated with respective throughputs 605 of 60 (MB/sec) and 20 (MB/sec) are 1.5 and 0.25, which are stored in the volume data table 600.

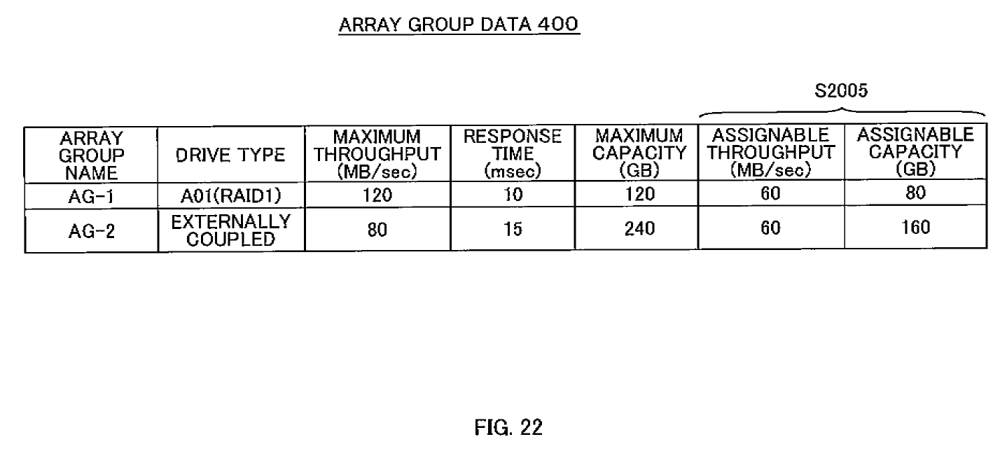

Next, for the existing volume 22A determined to be in use, values of the acquired throughput 605 and capacity 603 are subtracted from the assignable throughput 406 and capacity 407 of the array group data table 400 (S2005). FIG. 22 shows an example of the array group data table 400 updated by this process.

### Performance/Capacity Assignment

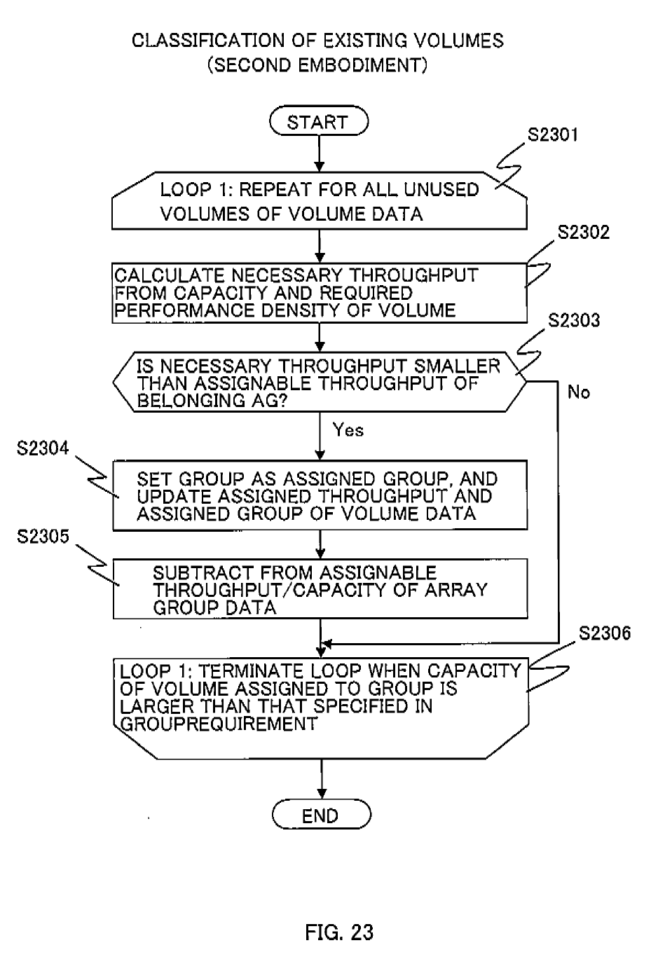

A processing flow for performance/capacity assignment calculation to be performed in the second embodiment is shown in FIG. 23.

In S2301, the configuration management unit 13 of the management server apparatus 10 repeats processing S2302 to S2306 for all unused (determined to be not in use) volumes 22A recorded in the volume data table 600.

First, the configuration management unit 13 calculates a necessary throughput from the capacity 603 and required performance density for a group 22 to be assigned, of each unused volume 22A (S2302). In this example, for volumes “1-2” and “1-3,” the throughput in “Group 1” is given by 40×1.5=60 (MB/sec), and that in “Group 2” is given by 40×0.6=24 (MB/sec). In the same manner, for volumes “2-2” and “2-3,” 120 (MB/sec) is given as the throughput in “Group 1, and 48 (MB/sec) is given as that in “Group 2”.

Next, the configuration management unit 13 determines whether or not the necessary throughput calculated in S2302 is smaller than the assignable throughput of an array group to which the volume 22A belongs (S2303).

When determined that the necessary throughput is smaller than the assignable throughput (Yes in S2303), an assigned group in the volume data table 600 is updated to the above group, and the assigned throughput is updated to the necessary throughput (S2304).

In this example, only volume “1-1” is assignable to group 1.

Subsequently, the configuration management unit 13 subtracts an amount of assigned throughput from the assignable throughput 406 of the array group 21A to which the assigned volume 22A belongs (S2305).

In S2306, it is determined whether or not the process has been completed for all the unused volumes 22A. When determined that the total amount of the capacity of the volumes 22A assigned to the group is larger than the capacity in a group requirement set by the administrator, processes in this flow are terminated.

It can be seen that the necessary capacity of the group requirement data table 500 illustrated in FIG. 14 is not satisfied in the above example.

By repeating the above processing flow for each group 22, the classification of the existing volumes 22A into each group (Tier) 22 is completed.

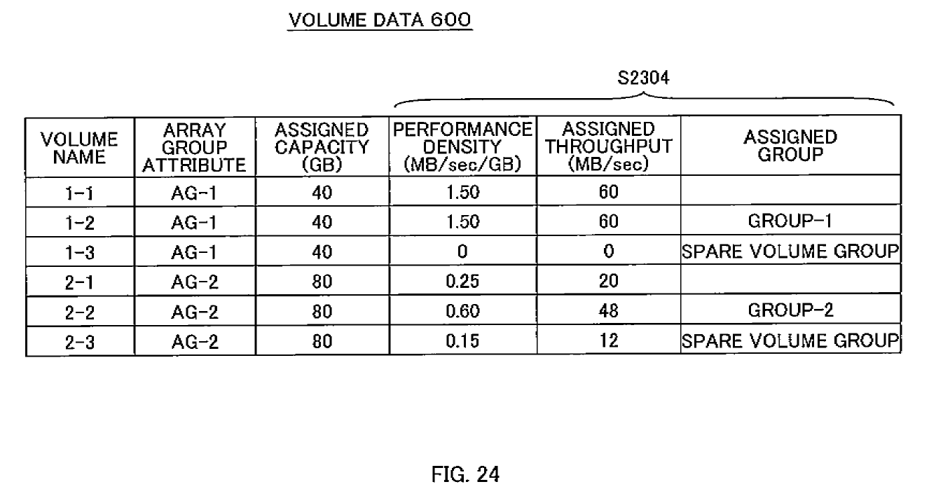

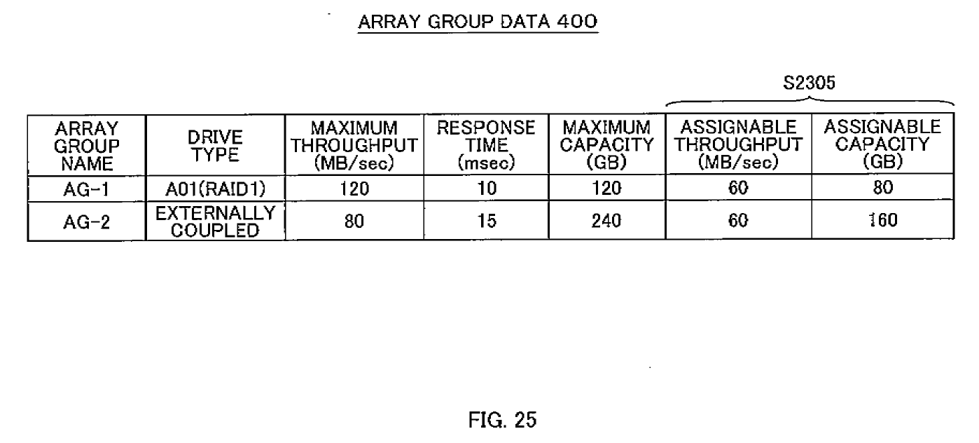

In FIGS. 24 and 25, shown are examples of the volume data table 600 and the array group data table 400 created or updated in the assignment processing of the existing volumes 22A in the second embodiment.

In accordance with the present embodiment, even when existing volumes 22A are present in the storage apparatus 20, it is possible to assign performance and capacity provided by these volumes to each application in a good balance so as to efficiently use the storage resources.

### Third Embodiment

The first and second embodiments each have a configuration in which logical volumes 22A are used by grouping them into groups 22, or when necessary, by configuring the group with a pool of virtual volumes 23. However, in the present embodiment, such grouping is not made, and performance and capacity are set for each logical volume 22A.

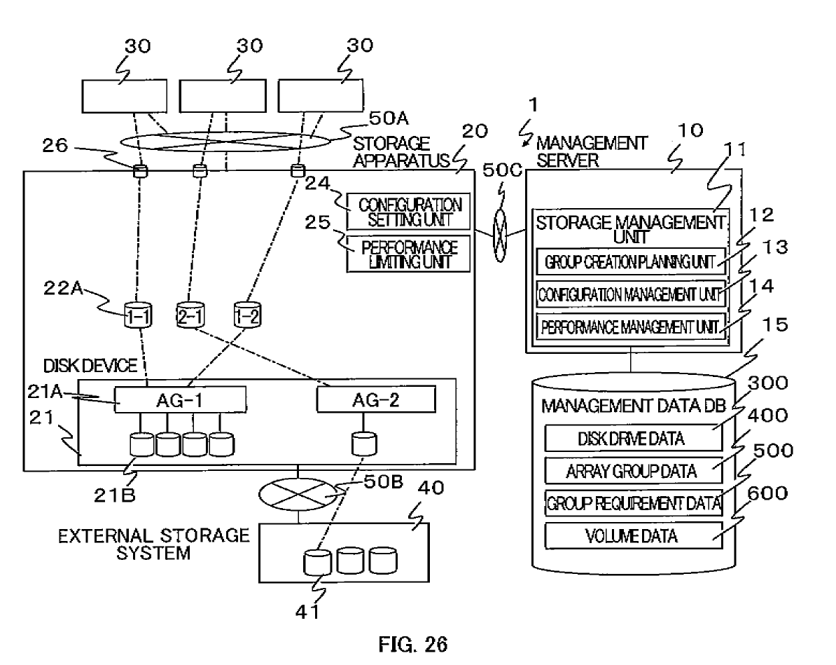

FIG. 26 shows a system configuration of the third embodiment. As is clear from the drawing, the system configuration of this embodiment is the same as those of the first and second embodiments, except for the point that groups 22 are not formed. In other words, for each application of the service server apparatus 30, a single logical volume 22A is assigned. Incidentally, the configurations of data tables are the same as those of the first and second embodiments.

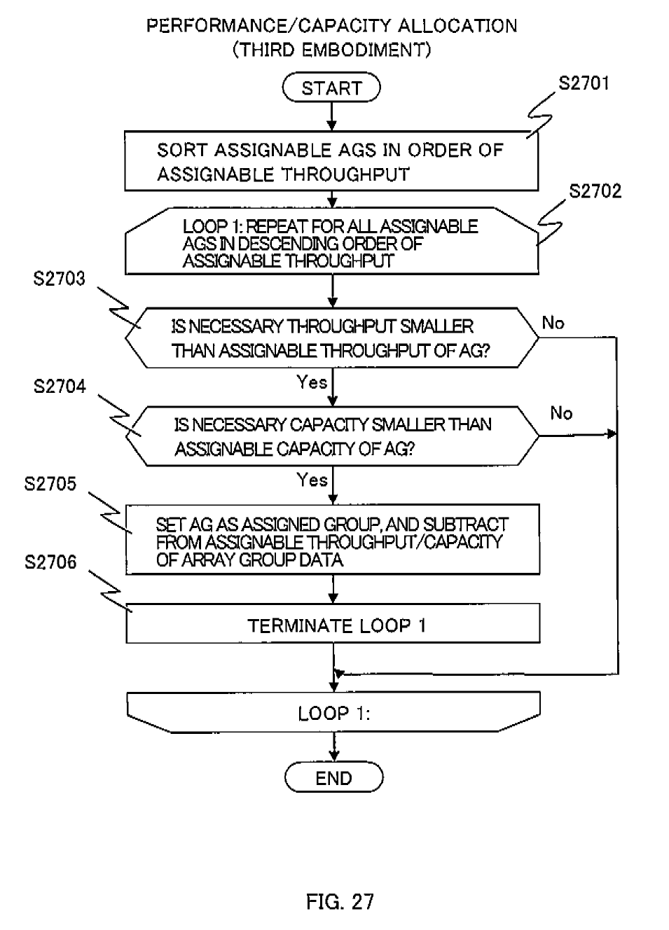

FIG. 27 shows an example of a process flow changed for this embodiment. In this embodiment, the requirement setting (S1202 of FIG. 12) of each group 22 made by the administrator in the first embodiment becomes requirements for each volume 22A. Further, the scheme of the performance/capacity assignment calculation (S1207 of FIG. 12) is changed to that of “assignment in descending order of performance of the array groups 21A.”

First, the configuration management unit 13 of the management server apparatus 10 sorts assignable array groups selected in S1206 of FIG. 12 in descending order of the assignable throughput 406 (S2701).

In S2702, the configuration management unit 13 repeats processing S2703 to S2706 for all assignable array groups 21A in descending order of the assignable throughput 406.

First, the configuration management unit 13 determines whether or not the necessary throughput inputted by the administrator in S1202 of FIG. 12 is smaller than the assignable throughput 406 of the array group 21A (S2703).

When determined that the necessary throughput is smaller than the assignable throughput 406 (Yes in S2703), the configuration management unit 13, further, determines whether or not the necessary capacity 1303 inputted by the administrator is smaller than the assignable capacity 407 of the array group 21A (S2704).

When determined that the necessary capacity 1303 is smaller than the assignable capacity 407 (Yes in S2704), the array group 21A is determined to be an assigned array group, and the assignable throughput 406 and the assignable capacity 407 in the array group data table 400 are subtracted (S2705).

Since the assigned array group 21A has been determined in the processes of up to S2705, Loop 1 is terminated, and the process returns to the process flow of FIG. 12.

For array group 21A, when determined that the necessary throughput is not smaller than the assignable throughput 406 (No in S2703), or when determined that the necessary capacity 1303 is not smaller than the assignable capacity 407 (No in S2704), the process moves to the processing for the next assignable array group 21A.

According to the present embodiment, for each application, assignable array groups 21A can be assigned in descending order of performance.

What is claimed is:

1. A storage system managing a storage device providing a storage area, the storage system comprising:
a storage management unit which
holds performance information representing I/O performance of the storage device, and capacity information representing a storage capacity of the storage device, the performance information including a maximum throughput of the storage device;
receives performance requirement information representing I/O performance required for the storage area, and capacity requirement information representing a requirement on a storage capacity required for the storage area, the performance requirement information including a required throughput;
selects the storage device satisfying the performance requirement information and the capacity requirement information; and
assigns, to the storage area, the required throughput included in the received performance requirement information, and assigns, to the storage area, the storage capacity determined on the basis of the capacity requirement information, the required throughput provided by the storage device with the maximum throughput of the storage device included in the performance information set as an upper limit, the storage capacity provided by the storage device with a total storage capacity of the storage device set as an upper limit.

2. The storage system according to claim 1,
wherein the storage management unit monitors an input/output of data to/from the storage area on the basis of the I/O performance assigned to the storage area.

3. The storage system according to claim 1,
wherein the performance requirement information includes performance density represented by a ratio between a throughput being I/O performance required for the storage area to which the throughput is assigned, and a storage capacity required for the storage area; and
wherein the storage management unit determines the required throughput to be assigned to the storage area on the basis of the performance density and the received capacity requirement information.

4. The storage system according to claim 1,
wherein the performance requirement information includes performance density represented by a ratio between a throughput being I/O performance required for the storage area to which the throughput is assigned, and a storage capacity required for the storage area; and
wherein the storage management unit determines the storage capacity to be assigned to the storage area on the basis of the performance density and the maximum throughput recorded in the performance information of the storage device providing the storage area.

5. The storage system according to claim 4,
wherein the storage management unit
holds the upper limit throughput having already been assigned to one or a plurality of the storage areas from the storage device;
calculates a remaining throughput of the storage device from the maximum throughput recorded in the performance information of the storage device and the assigned upper limit throughput; and
determines the storage capacity to be assigned to a new one of the storage areas on the basis of the performance density and the remaining throughput.

6. The storage system according to claim 1, further comprising a group formed of one or a plurality of the storage areas,
wherein the storage management unit
receives the performance requirement information and the capacity requirement information, the performance requirement information including the performance density; and
assigns one or a plurality of the storage devices to the storage areas forming the group so that each of the storage areas satisfies the performance density and that a total storage capacity of all the storage areas forming the group satisfies the capacity requirement information, when assigning the storage areas to the group.

7. The storage system according to claim 6,
wherein the storage management unit assigns, for each of the plurality of storage devices determined to satisfy the performance requirement information, a storage capacity defined in the capacity requirement information to each of the storage devices so that the storage capacity corresponds to a ratio of the maximum throughput of each of the storage devices.

8. The storage system according to claim 6,
wherein the group is a storage capacity pool formed of one or a plurality of the storage areas assigned from one or a plurality of the storage devices by using a storage virtualization mechanism.

9. The storage system according to claim 6,
wherein the group is a storage area to/from which data is inputted/outputted by a particular application.

10. The storage system according to claim 1,
wherein the storage area provided by the storage device is a logical volume.

11. The storage system according to claim 10,
wherein the storage management unit creates the storage area as the logical volume provided by the storage device, when assigning the storage area to the group.

12. The storage system according to claim 10,
wherein the storage management unit
holds the capacity information of the logical volume having already been created in the storage device;
receives the performance requirement information and the capacity requirement information for the group to be newly created;
determines a required throughput to be assigned to the logical volume from the performance density included in the performance requirement information and the capacity information of the logical volume; and
assigns the required throughput to the logical volume as the upper limit throughput, when a remaining throughput of the storage device including the logical volume exceeds the required throughput, and
wherein the group is formed so that a total capacity of one or a plurality of the logical volumes to which the upper limit throughput is assigned satisfies the capacity requirement.

13. The storage system according to claim 12,
wherein the logical volume having already been created has not been assigned to the other group.

14. The storage system according to claim 1,
wherein when there is the logical volume which has been assigned to the group and to which the upper limit throughput has not been assigned, the upper limit throughput to be assigned to the logical volume is determined by measuring a maximum actual throughput of the logical volume.

15. In a storage system including a storage management unit managing a storage device providing a storage area, an operation method comprising the steps of:
holding performance information representing I/O performance of the storage device, and capacity information representing a storage capacity of the storage device, the performance information including a maximum throughput of the storage device;
receiving performance requirement information representing I/O performance required for the storage area, and capacity requirement information representing a requirement on a storage capacity required for the storage area, the performance requirement information including a required throughput;
selecting the storage device satisfying the performance requirement information and the capacity requirement information; and
assigning, to the storage area, the required throughput included in the received performance requirement information, and assigning, to the storage area, the storage capacity determined on the basis of the capacity requirement information, the required throughput provided by the storage device with the maximum throughput of the storage device included in the performance information set as an upper limit, the storage capacity provided by the storage device with a total storage capacity of the storage device set as an upper limit.
